(19) United States
(12) Patent Application Publication
(10) Pub. No.: US 2005/0026294 A1
(43) Pub. Date: Feb. 3, 2005

(54) Devices and methods for determining and predicting breakthrough times and steady state permeation rates of organics

(76) Inventor: Alan C. Barber, Research Triangle Park, NC (US)

Correspondence Address: MYERS BIGEL SIBLEY & SAJOVEC, PO BOX 37428, RALEIGH, NC, 27627, US

(21) Appl. No.: 10/902,454

(22) Filed: Jul. 29, 2004

Related U.S. Application Data
(60) Provisional application No. 60/490,684, filed on Jul. 29, 2003.

(51) Int. Cl. G01N 31/00

(52) U.S. Cl. 436/8; 422/54

(57) ABSTRACT

Methods and devices for determining the breakthrough times and steady state permeation rates of a chemical sample through a material and calibration methods that utilize the principal of relative carbon response factors using flame ionization responses of a reference gas.

### CROSS-REFERENCE TO RELATED APPLICATIONS

This application claims the benefit of, and incorporates herein by reference in its entirety, the following U.S. Provisional Application: U.S. Provisional Application No. 60/490,684, filed Jul. 29, 2003.

### FIELD OF THE INVENTION

This invention relates to the permeation of materials and fabrics, and in particular to methods and devices for determining the breakthrough time and permeation of liquids or vapors through materials or fabrics.

### BACKGROUND OF THE INVENTION

Liquid permeation testing is an analytical technique used to evaluate the barrier properties of materials, such as gloves, gowns, chemical suits, other protective clothing, films, membranes, and other materials under the condition of continuous contact. The effectiveness of a barrier is determined by two key parameters: breakthrough time and steady state permeation rate. The breakthrough time is defined as the length of time required for a particular chemical to pass through the barrier at a specific concentration per unit time. The steady state permeation rate occurs at the time when all forces affecting permeation have reached equilibrium and permeation occurs at a constant rate. The information obtained from liquid permeation testing is often used in the process of selecting the most appropriate gloves or other protective clothing for a specific application. For example, liquid permeation data can be used to determine which glove material provides the best protection against permeation of a specific chemical.

One of the primary components of a liquid permeation system is the detector. A flame ionization detector (FID) is generally considered to be one of the most universal detectors because it has a broad linear range covering approximately seven orders of magnitude and is highly sensitive to nearly all carbon-containing chemicals. The universal nature of the FID makes it a logical choice for chemical permeation testing because the majority of chemicals being used for liquid permeation measurements are organic compounds. Calibration of the detector is one of the most important considerations when working with an FID. As currently practiced, liquid permeation testing requires tedious calibration using standards for each individual chemical being tested.

In 1981 the ASTM method F739 was published. Since that time, it has become the widely recognized method for determining the resistance of protective clothing materials to permeation by liquids under conditions of continuous contact. Due to the wide array of chemicals that workers can be potentially exposed to, there is great interest in obtaining permeation data for hundreds of different chemicals.

Traditionally, tests to determine the breakthrough time and steady state permeation rate of different compositions, such as organic solvents, required that a testing device be calibrated for the particular sample being tested before running any tests. To test the same material or fabric sample with another composition often required re-calibration of the testing device for the new composition. These methods result in time consuming calibration and testing procedures. It is desirable, therefore, to develop a device for testing the breakthrough times and steady state flow rates of various chemicals through materials and fabrics without the need for repetitive calibration. Further, methods for determining breakthrough times and steady state permeation rates for multiple sample chemicals using a single reference calibration are desirable.

### SUMMARY OF THE INVENTION

Embodiments of the present invention relate to the permeation of materials and fabrics and in particular to methods and devices for determining the permeation of a liquid or gas substance through materials and fabrics.

According to embodiments of the present invention, liquid permeation testing devices may be used to determine calibration curves from optimized FID responses to various reference gases. The calibration curves may then be used to predict or determine the breakthrough times and/or steady state permeation rates of chemical samples through protective materials. The calibration curves are modeled on the relative carbon response factors of the reference gas and the chemical samples being analyzed. The relative carbon response factors are influenced by the number of carbons per molecule of the reference gas and chemical sample.

Various embodiments of the present invention also provide liquid permeation testing devices that may be used to determine the breakthrough times and steady state permeation rates of chemical samples using flame ionization detectors, or other types of detectors, such as: photoionization detectors (PID), thermal conductivity detectors (TCD), and discharge ionization detectors (DID).

In certain embodiments of the invention an FID is optimized. Following optimization, a linear calibration curve for flame ionization responses to differing amounts of a reference gas are plotted. From the linear curve, an equation is produced for determining the breakthrough response value of the flame ionization detector for a given chemical sample. The breakthrough response value is based, in part, upon the relative difference in the number of carbons in a chemical sample and the reference sample and on the molecular weight of each sample. A flame ionization test may then be run with the chemical sample until the calculated breakthrough response is met. The time required to meet the calculated response is the breakthrough time for the chemical sample.

In other embodiments a calibration curve is developed from responses of an optimized FID to a reference sample in order to determine the steady state permeation rate of a chemical sample based upon that of a reference sample. From the linear calibration curve an FID response may be predicted for the steady state permeation rate of a chemical sample. The prediction is based in part on the number of carbons of the chemical sample and reference sample, as well as the molecular weight of the two samples.

### BRIEF DESCRIPTION OF THE DRAWING FIGURES

The invention can be more readily ascertained from the following description of the invention when read in conjunction with the accompanying drawings in which:

FIG. 1 illustrates a liquid permeation testing device according to embodiments of the present invention;

FIG. 2 illustrates a display of a computing device used with embodiments of the present invention;

FIG. 3 illustrates a frontal view of a sampling device according to embodiments of the present invention;

FIG. 4 illustrates a top-down view of various components of a sampling device according to embodiments of the present invention;

FIG. 5 illustrates a gas divider according to embodiments of the present invention;

FIG. 6 illustrates a block diagram of an alternate embodiment of the sampling device of the present invention;

FIG. 7 illustrates a block diagram of a sampling cell according to embodiments of the present invention;

FIG. 8 illustrates an FID response to a hexane gas standard;

FIG. 9 illustrates an optimized FID response to a hexane gas standard at a constant flow rate;

FIG. 10 illustrates non-optimized FID responses to hexane gas standards;

FIG. 11 illustrates optimized FID responses to hexane gas standards;

FIG. 12 illustrates FID response factors relative to hexane derived from literature data;

FIG. 13 illustrates FID carbon response factors relative to hexane;

FIG. 14 illustrates the dependence of carbon content based response factors on the weight fraction of the heteroatoms;

FIG. 15 illustrates FID relative carbon response factor dependence on heteroatom content, hydrocarbons, chlorine, bromine, and sulfur;

FIG. 16 illustrates FID relative carbon response factor dependence on heteroatom content, oxygen, and nitrogen;

FIG. 17 illustrates an FID response for acetone permeation according to embodiments of the present invention;

FIG. 18 illustrates an FID calibration curve for a hexane reference gas that may be used to calculate breakthrough time for other chemical samples;

FIG. 19 illustrates a block flow diagram of a process for establishing breakthrough times from FID responses to a reference gas according to embodiments of the invention; and

FIG. 20 illustrates an FID calibration curve for a hexane reference gas that may be used to calculate steady state permeation rates for other chemical samples.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout.

Embodiments of the present invention include liquid permeation testing devices for monitoring the permeation of chemical samples through protective materials.

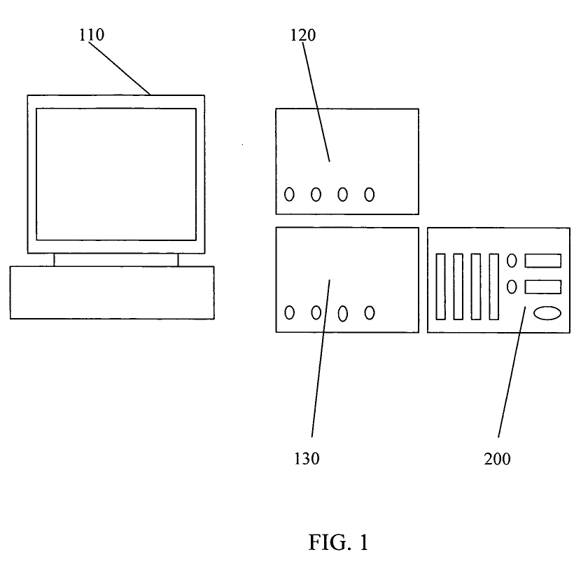

Liquid permeation testing devices according to embodiments of the present invention comprise open-loop continuous monitoring units for monitoring the concentration of particular chemical samples in a gas. As shown in FIG. 1, a liquid permeation testing device may include numerous pieces of equipment. In other embodiments, all of the necessary equipment may be contained in a single, stand-alone unit (not shown). The liquid permeation testing device 100 illustrated in FIG. 1 includes a computing system 110, two electrometers 120 and 130, and a sampling device 200. The computing system 110 monitors output from the sampling device 200 and/or the two electrometers 120 and 130 based upon samples attached or fed to the sampling device 200. From the data collected by the computing system 110 breakthrough times and steady state permeation rates of various chemical samples permeating protective materials can be determined.

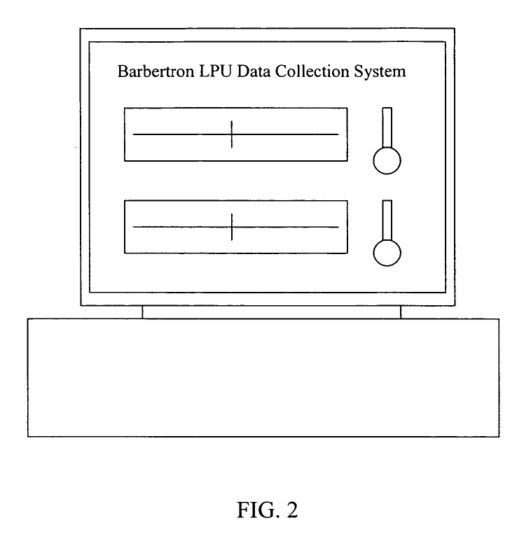

The computing system 110 may include software or hardware for converting input from the sampling device 200 or electrometers 120 and 130 into visual and/or numerical data. The software and/or hardware may include custom programming or programming designed and distributed for use with the particular electrometers 120 and 130 and/or sampling device 200. For instance, Dow Reichhold has developed a software suite for collecting data from the electrometers 120 and 130 and sampling device 200 that may be installed on the computing system. The software suite offered by Dow Reichhold includes National Instruments LabVIEW software and custom programming to collect and quantify signals from the sampling device 200 and electrometers 120 and 130. FIG. 2 illustrates a data screen for recording voltage data from the two electrometers 120 and 130. The data may be collected and stored by the computing system 110 such as in a memory or as files written to storage media.

The electrometers 120 and 130 are connected to the sampling device 200 and the computing system 110. The electrometers 120 and 130 are connected to flame ionization detectors (FID) operating within the sampling device 200, such as GOW-MAC model 12-800 flame ionization detectors. Reponses from the FIDs in the sampling device 200 produce voltage responses that are determined by the electrometers 120 and 130 and communicated to the computing system 110. Each of the electrometers 120 and 130 include controls 122 for adjusting the sensitivity of the signal from the FIDs. The sensitivity ranges of the electrometers 120 and 130 may be adjusted using the controls 122 as known with FID sensitivity selections.

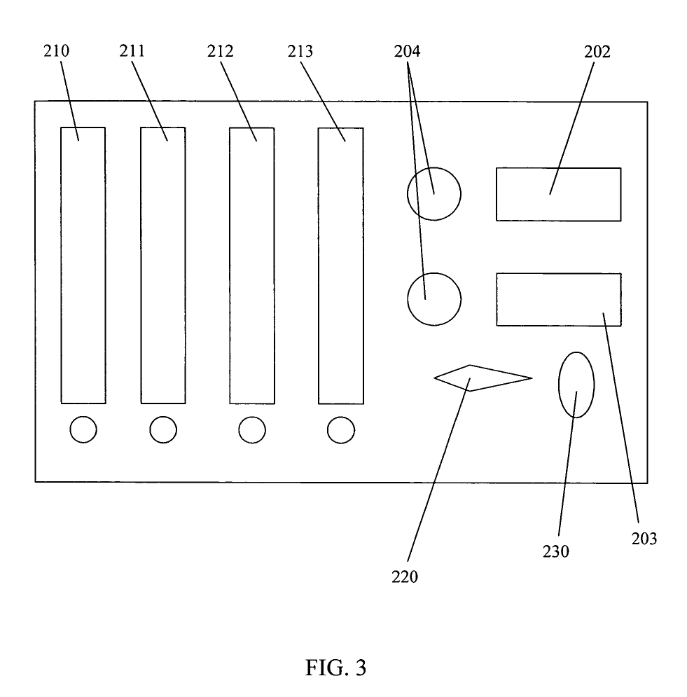

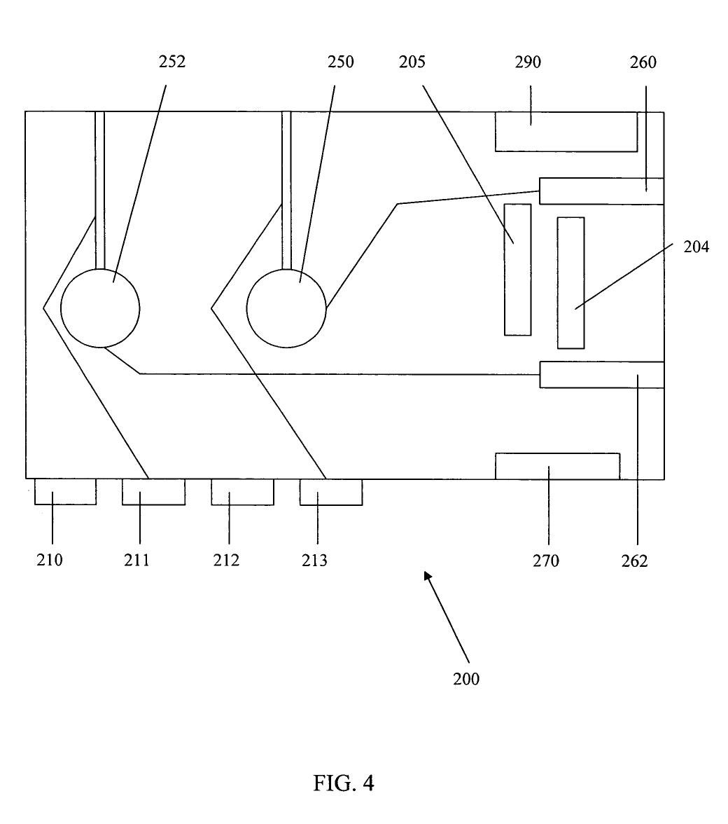

An example of a sampling device 200 that may be used with embodiments of the present invention is illustrated in FIGS. 3 and 4. FIG. 3 illustrates an outside view of the sampling device 200 showing mass flow controller readouts 202 and 203, flow meters 210-213, a calibration switch 220, a power switch 230 and mass flow controller adjustments 204.

The components of the sampling device 200 are illustrated in the top-down view of the sampling device 200 provided in FIG. 4. The sampling device 200 includes FIDs 250 and 252, flow meters 210-213, mass flow controllers 204 and 205, and sampling ports 260 and 262. Although the sampling device 200 is illustrated with two FIDs and two mass flow controllers, it is understood that any number of FIDs and mass flow controllers may be incorporated with the sampling device 200. Furthermore, the flow meters 210-213 may incorporate digital readouts and monitoring.

Sampling device 200 may also include a cooling source 290, such as a fan, for removing excess heat from the sampling device 200. A power source (not shown) may also be added to the sampling device 200 to provide power to the components of the sampling device 200. Elements for heating or preheating the FIDs 250 and 252 during operation may also be included with the sampling device 200. Calibration circuitry 270 may also be included in the sampling device 200 for calibrating or obtaining calibration data for the sampling device 200 at start-up or before sampling.

In operation, a chemical sample is fed to the sampling device 200 through one or more of the sampling ports 260 at a constant flow rate. The chemical sample includes a carrier gas for transporting the chemical sample through the sampling device 200. The flow of the sample is monitored and controlled by the mass flow controllers 204 and/or 205 and fed to the FIDs 250 and/or 252. The FIDs ionize the chemical sample using a flame produced with oxygen and hydrogen. The ions and free electrons formed in the flame of the FID are monitored by a potential difference between two electrodes in the FID. As the ions and free electrons are released, a change in resistance between the electrodes of the FID results. The change in resistance across the electrodes causes a current to flow which is monitored and amplified by an electrometer 120 and/or 130 connected to the FID. In this manner, a voltage for the chemical sample gas burned in the FID may be obtained and recorded.

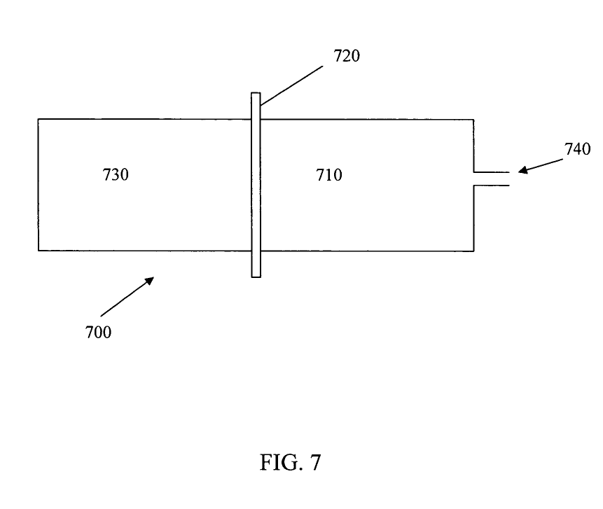

The sampling ports 260 and 262 may include any type of sampling port known to deliver a gas or chemical sample to a flow meter or FID. Preferably, sampling ports 260 and 262 include ASTM glass cells capable of holding a sample on one side of a material to be tested. Gas flow, such as nitrogen gas flow, occurs on the other side of the material to be tested. As the chemical sample permeates and passes through the material it is picked up by the nitrogen gas flow and transported to the FIDs 250 and/or 252 where a voltage corresponding to the amount of chemical sample in the gas flow is determined. A simplified illustration of a glass cell is shown in FIG. 7. The glass cell 700 includes a sample portion 730 for holding a gas or liquid sample for testing, a material 720 that is being tested for permeability or breakthrough time, and a gas flow portion 710 wherein a carrier gas passes over the material 720 and collects any chemical sample that permeates through the material 720 from the sample portion 730 of the glass cell 700. The carrier gas and any chemical sample collected passes through interface 740 to a sampling device 200 according to the embodiments of the invention.

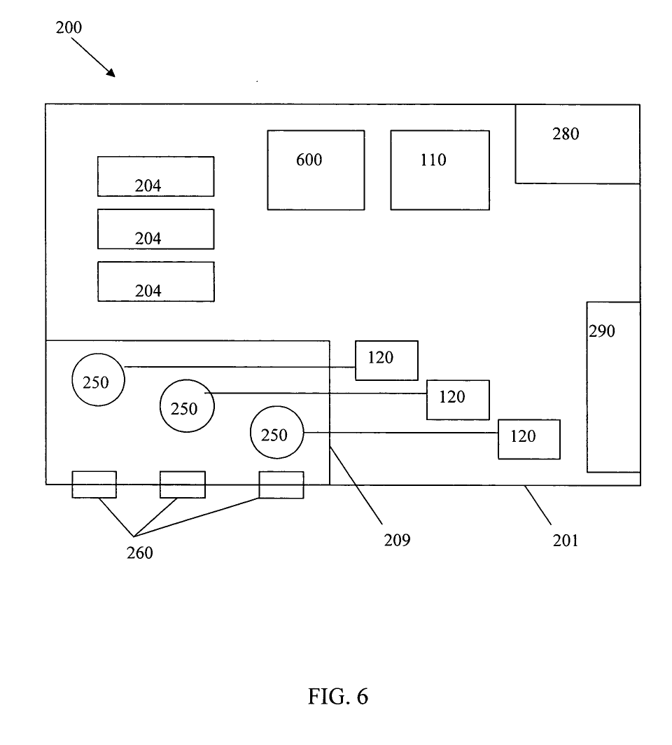

In other embodiments of the present invention the sampling device 200 may include additional components for improving the sampling ability of the liquid permeation testing devices of the present invention. A block diagram of an alternate sampling device 200 is illustrated in FIG. 6. The sampling device 200 includes a shell 201 or encasement for holding and/or mounting all of the components of the sampling device. The shell 201 may be modified or configured as a stand-alone device or a rack-mounted device. The shell 201 may also include room for expanding, upgrading, or otherwise adding additional components to the sampling device 200, such as additional detectors.

The sampling device 200 illustrated in FIG. 6 includes mass flow controllers 204 and FIDs 250. Although three mass flow controllers 204 and three FIDs 250 are shown in the sampling device 200 it is understood that the number of mass flow controllers 204 and FIDs 250 may be one or more. The FIDs are shown within a heating block 209 of the sampling device 200. The heating block 209 can be heated to provide additional heat to the FIDs 250, which heat may be used to warm the FIDs 250 and improve the accuracy of the results from the FIDs 250. Sampling ports 260 are also included in the sampling device 200. As shown, the sampling ports 260 may enter the sampling device 200 within the heating block 209 in order to provide heat to the sampling ports 260. Additional heat in the sampling ports 260 helps to prevent the gumming of the sampling ports by viscous chemical samples tested by the sampling device 200. As an alternative, heating wires, filaments, coils, or other heat providing sources may be wrapped about the FIDs 250 and/or flow lines to heat the respective components.

The sampling device 200 may also include a cooling unit 290, such as a fan, for cooling the components of the sampling device 200 and removing fumes from within the sampling device 200. A power unit 280 may also be incorporated with the sampling device 200 to provide an internal power source for the sampling device 200. The internal power source 280 can provide power for operating the components of the sampling device 200 and for heating filaments (not shown) used in the device to preheat components of the sampling device 200, such as the FIDs 250 and sample flow lines.

In certain embodiments, electrometers 120 may be incorporated within the sampling device 200 to measure the current changes in the FIDs 250 and amplify the responses. Data from the electrometers 120 may be fed to a computing system 110 within the sampling device 200 or outside the sampling device 200 for recordation and analysis. The computing system 110 may include display devices, memory devices, input devices and output devices.

The sample and gas lines within the sampling device 200 may be made from materials that are resistant to or inert in the gases and chemicals that are to be tested with the sampling device 200. For example, the gas flow lines may be stainless steel, glass lined stainless steel, or polytetrafluoroethylene (PTFE).

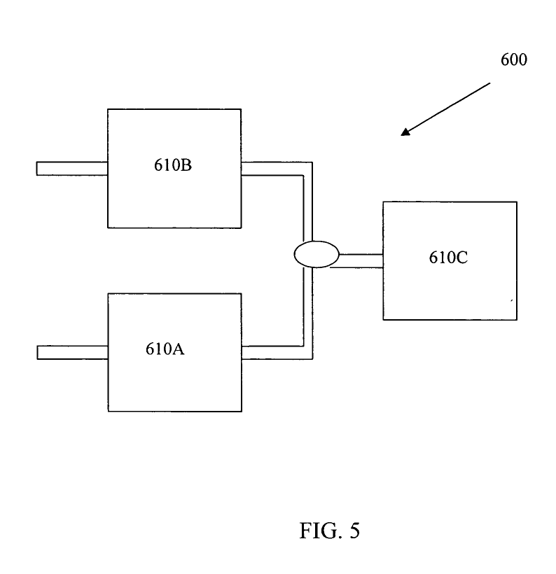

The sampling device 200 may also include a gas divider 600. A freestanding gas divider 600 is illustrated in FIG. 5 and may be incorporated with the various embodiments of the present invention. The illustrated gas divider 600 includes three gas flow meters 610 for regulating gas flow. A gas divider 600 receives gasses from gas sources and combines the gases or divides the gasses to create a resulting gas flow. For instance, a first gas flow may be fed to a first flow meter 610A and a second gas flow to a second flow meter 610B. The flow meters can be adjusted to produce a desired flow of each gas, for example 20 milliliters per minute from the first flow meter 610A and 30 milliliters per minute from the second flow meter 610B. The gas flows from the two gas flow meters may be combined and sent to a third gas flow meter 610C that regulates the combined gas flow to 50 milliliters per minute. The regulated gas flow may then be fed to a sampling device 200. The gas divider 600 provides an instrument for producing a nearly infinite number of concentrations from a single standard with a fixed and known concentration, which can assist in calibrating or optimizing the liquid permeation testing devices of the present invention.

A calibration valve 220 allows for instant calibration of the instrument by diverting the nitrogen flow to the detectors and replacing it with a known concentration of hexane gas. The subsequent voltages obtained from the FIDs can then be compared to previous voltage data to verify that the instrument is operating within acceptable control limits.

Embodiments of the present invention also include calibration methods that may be used with liquid permeation testing equipment and devices. The calibration methods of the present invention may be used to determine the breakthrough times and/or steady state permeation rates of various samples through protective materials. To perform the calibration methods of the present invention a detector, such as an FID, is optimized to produce a linear curve of FID responses for varying amounts of the reference material. FID responses for various sample chemicals may then be taken and compared to the reference material based on the reference curve to determine the breakthrough time and steady state permeation rates of the sample chemicals. The optimization of the FID and steps of the calibration methods of the present invention are further explained herein.

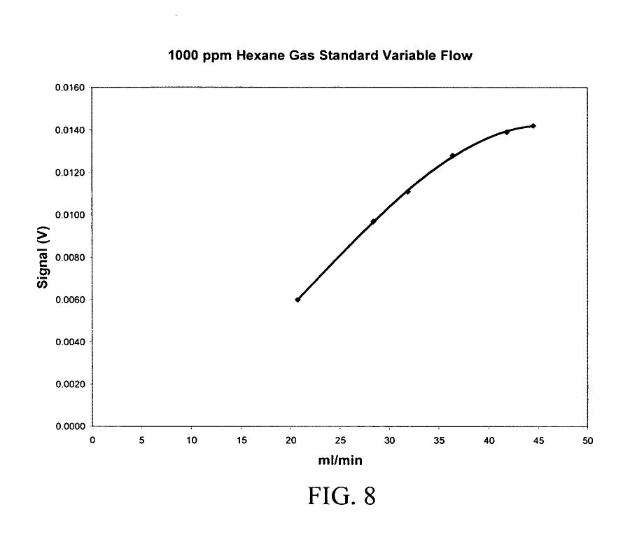

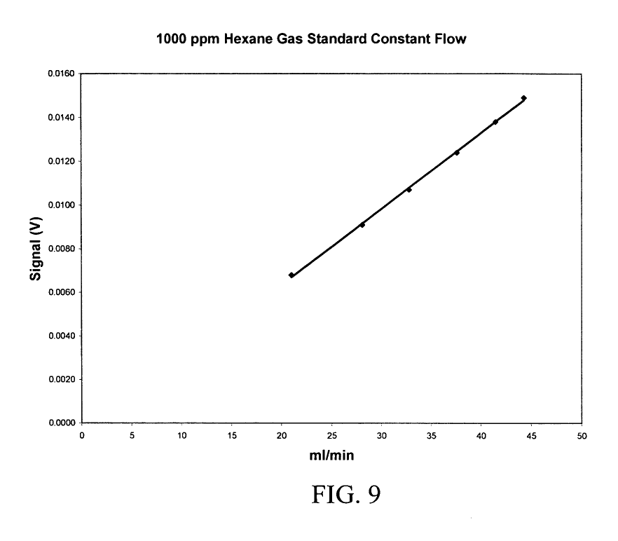

According to embodiments of the present invention the universal calibration methods rely upon the generation of linear responses from a detector, such as an FID, to a reference gas stream. Traditionally, detectors, such as FIDs, do not produce linear responses for various gas flow rates. For example, FIG. 8 illustrates an FID response to various volumetric flow rates of a 1000 ppm hexane gas. The response curve over the range of volumetric flow rates is not linear. It has been found, however, that when the total gas flow rate to an FID is held constant the detector produces a linear response to the changing volumetric flow rate of the gas being tested. This is illustrated in FIG. 9. The linear response of a detector is dependent on a constant total volumetric flow rate of gas supplied to the detector. For the purposes of this invention the optimization of an FID occurs when the detector is operated with a constant total flow rate to achieve responses from the FID, which responses may be plotted to form a linear curve for a reference gas.

Hexane gas was used as the reference gas to produce the curve in FIG. 9. Although the volumetric flow rates of hexane gas used to produce the linear curve of FIG. 9 were varied, the total flow rate of gas to the FID was not. The curve illustrated in FIG. 9 was produced by maintaining a constant total flow rate of 50 ml/min of gas to the FID. In those instances where the flow rate of the 1000 ppm hexane sample were below 50 ml/min, nitrogen was added to the balance of the total flow to ensure a total flow rate of 50 ml/min to the FID. For example, the total flow of gas to the FID to determine the data point corresponding to a hexane flow rate of 20 ml/min comprised 20 ml/min of hexane and 30 ml/min of nitrogen (N₂). The detector response to the constant flow rate resulted in the linear appearance of the curve.

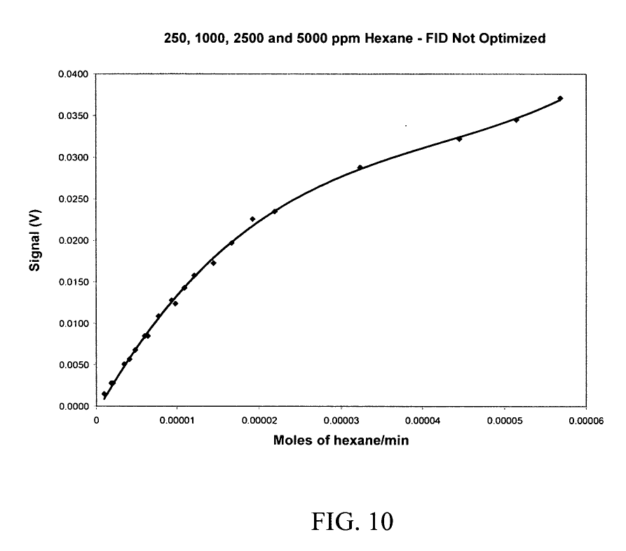

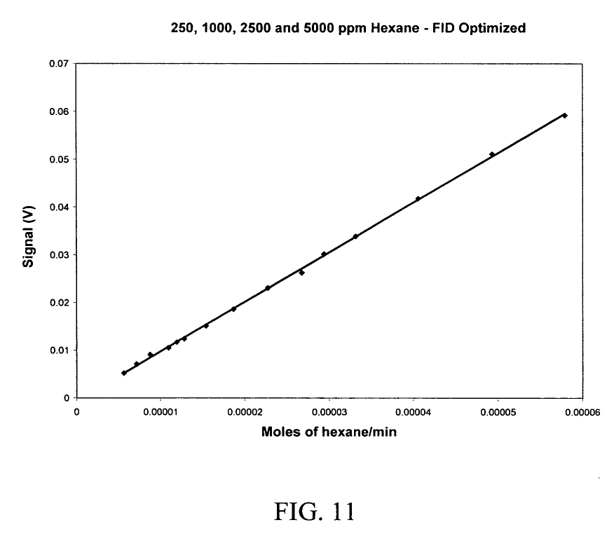

In order to obtain a linear curve of FID response signals for a particular gas the total flow rate of gas to the FID must remain constant despite changes in the volumetric flow rates or mass flow rates of the gas being tested. FIG. 10 illustrates a response curve for hexane where the flow rates of gas to the FID were not kept constant, but instead, were based upon the FID manufacture's suggested flow rates. In comparison, the linear response illustrated in FIG. 11 is comprised of FID data for the same molar flow rates of hexane fed to the FID using a fixed total flow rate for each data point.

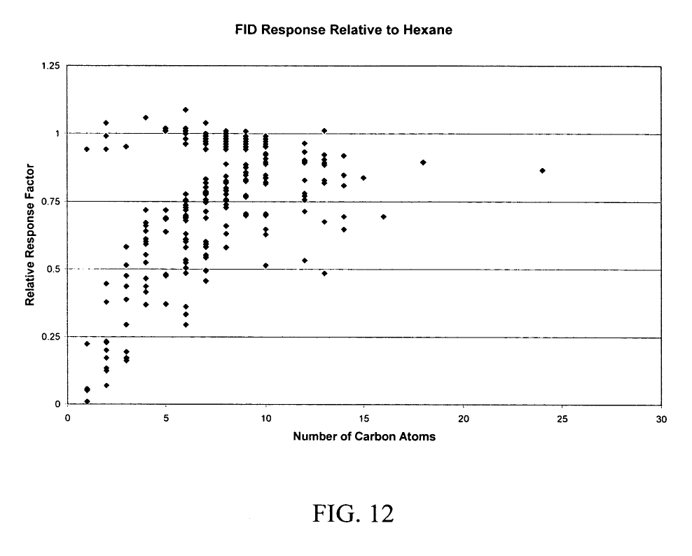

The response of an FID is known to be dependent on the specific compound being analyzed. The wide range of responses seen in practice generally leads to individual calibrations for each chemical being analyzed. The variations in FID responses for different chemicals are often expressed in terms of relative response factors (RRFs). The RRF for a substance is determined by dividing the FID response for a given mass of that substance by the FID response for the same mass of reference material. FIG. 12 shows RRF values for a wide range of organic compounds taken from the literature. Hexane is used as the reference material for the date in FIG. 12. The varying sensitivity of FIDs to different materials is illustrated by the 273 data points of FIG. 12, which represent over 250 unique chemical compounds and cover a wide range of classes of organic compounds. The RRF of a compound needs to be considered when applying an FID calibration made using a different compound.

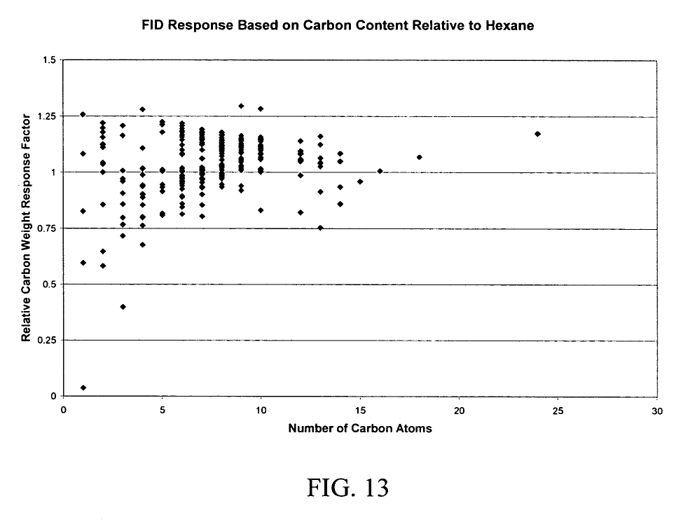

Since many aspects of the basic theory of the FID are poorly understood, no general predictive model is available for the RRF of a compound. Certain generalizations about FID responses are widely accepted; one is that the mole-based FID response is proportional to the carbon number of hydrocarbons (i.e. hydrocarbons display an equal-per-carbon response), and a second is that the FID response of substituted hydrocarbons is always less than that of the parent hydrocarbon. The concept of the RRF of an organic compound being largely dependent on the carbon content of the material has led to the approach of relative carbon weight response factors (RCRFs). RCRFs compensate for the carbon content of a compound by normalizing the RRF by the mass of carbon in the sample and the mass of carbon in the reference material. FIG. 13 shows the RCRFs for the same set of compounds shown in FIG. 12. A comparison of FIGS. 12 and 13 shows a significant decrease in the spread of the RCRF values compared to RRF values for the same compounds. This shows that much, but not all, of the variation in the RRF values for different compounds can be attributed to variation in the carbon content of the materials.

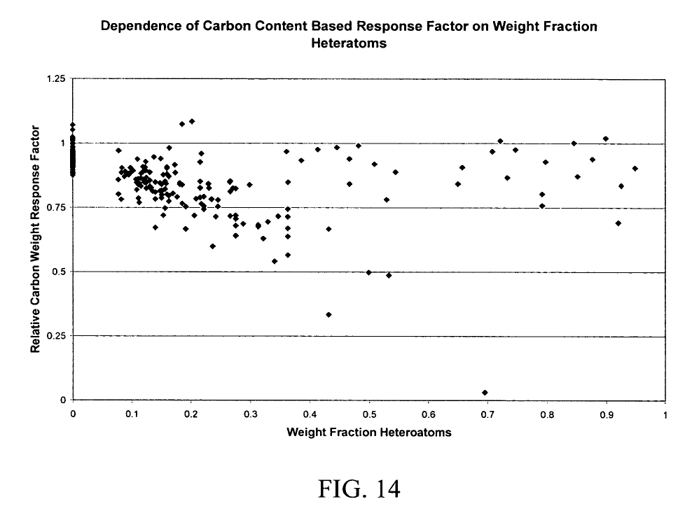

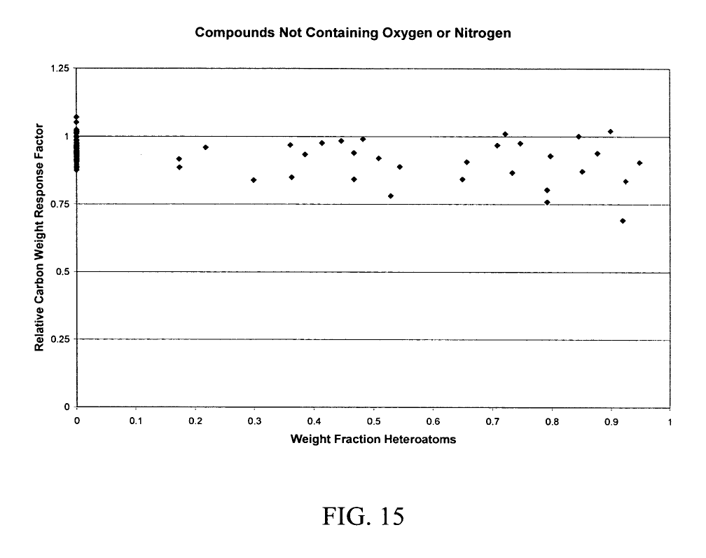

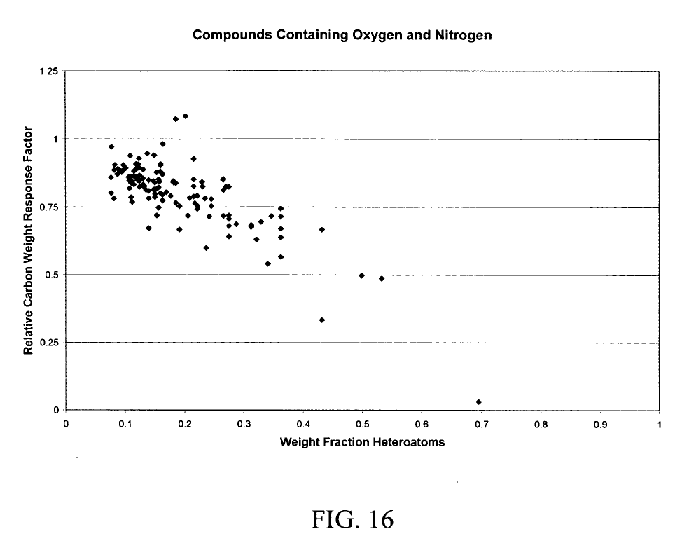

Most of the remaining discrepancies in the RCRF values are associated with the chemical composition of the compounds. This can be seen in FIG. 14, which plots the RCRF values for the compounds against the weight fraction heteroatom in the compound. The heteroatoms found in the compounds examined were oxygen, nitrogen, sulfur, bromine, and chlorine. The compounds show three distinct behaviors in FIG. 14. The hydrocarbons all fall on the ordinate axis (having no heteroatoms) and show relatively little scatter in their RCRF values. A second set of compounds is clustered parallel to the abscissa over a complete range of heteroatom content. This cluster shows little dependence of RCRF on heteroatom content and corresponds to the chlorine, bromine and sulfur containing compounds. It is shown along with the hydrocarbon cluster in FIG. 15. The third cluster of compounds corresponds to the oxygen and nitrogen containing compounds. These are plotted separately in FIG. 16. These compounds show a significant decrease in RCRF with increasing heteroatom content as indicated by the downward slope of the cluster. The presence of the three clusters of materials is a consequence of the carbon ionization mechanism by which FIDs operate. Certain heteroatoms, specifically nitrogen and oxygen, are known to interfere with the FID ionization mechanism.

According to embodiments of the present invention, an FID may be optimized to produce a linear response curve for a reference organic compound. Responses of the FID to sample chemicals can be compared to the FID responses of the reference compound to determine the breakthrough and steady state permeation rates of the samples. In practice, it is desirable to use reference chemicals that are highly pure, stable, easily handled, and accurately measured. Gravimetric alkane gas references, such as hexane standards, meet these criteria.

Calibration of a continuous flow system, such as a liquid permeation apparatus with an FID using gravimetric gas standards can be performed. A gas stream of known concentration is delivered to the detector at a fixed flow rate through the use of a flow splitter combining the calibration standard and nitrogen, thus a limited number of standards can be used to calibrate a wide range of concentrations. FIG. 11 is typical of a calibration curve generated in this manner. This calibration curve was generated using a hexane gas standard, but it can be extended to become a universal calibration curve. All that is needed is a method for relating the FID response of the compound being examined to the FID response of hexane.

The FID response of a sample can be related back to a hexane response using one of two approaches. Selection of the specific approach to use is dependent on the level of error that is acceptable. The simplest approach is to assume a similar carbon response factor to hexane. This approach has the greatest amount of associated error, and the level of error depends on the type of compound being examined. The data displayed in FIG. 15 shows that this approach is reasonable for hydrocarbons and compounds containing chlorine, bromine or sulfur. With hydrocarbons, results accurate to within 20% are expected. With the chlorine, bromine, or sulfur containing compounds, results within 25% are expected. Of the compounds of this type analyzed, only one, dibromomethane, falls outside of this error range. The error associated with dibromomethane is 31%. The data shown in FIG. 16 indicates that this approach is a poor one to use for many oxygen and nitrogen containing compounds. Errors in excess of 25% are typical for many of these compounds. The magnitude of the error grows as the heteroatom content of these compounds increases. For these compounds the second approach is preferable.

The second approach for relating the FID response of a sample to that of hexane is to use relative response data either from the literature or generated experimentally. FID response factors are available for many compounds in the literature. Response factors can be generated experimentally by injection of the sample material and hexane into an optimized FID system. The use of relative response data can significantly reduce the error associated with use of a universal calibration approach, particularly for samples showing a strong dependence on heteroatom content such as oxygen and nitrogen containing compounds. The error associated with this method is the error associated with the relative response factors.

According to embodiments of the present invention, the breakthrough time of a sample chemical through a protective material can be determined from the response signals of an optimized FID for a reference chemical. For instance, a breakthrough calibration curve may be established for hexane from which associated FID responses for the breakthrough time point of other sample chemicals may be determined. The breakthrough times for the sample chemicals are based upon a carbon to carbon comparison of the reference FID responses and the sample FID responses. An example according to embodiments of the present invention follows.

A breakthrough calibration curve for a reference chemical is established using a liquid permeation testing unit according to embodiments of the present invention. The liquid permeation testing unit includes one or more FIDs for producing responses to gases fed to an FID. The responses of the FID to the varying amounts of carbon in the flow rates of reference gas sampled may be plotted to predict the breakthrough times for other sample chemicals based upon the number of carbons in those sample chemicals.

The FIDs of the liquid permeation testing unit are optimized. In other words, samples of a known reference gas, such as hexane, are fed to the FID with nitrogen. The total flow of gas fed to the FID is not varied but the flow of reference gas in the total flow of gas is varied. A linear curve, such as those illustrated in FIGS. 9 and 11 indicates that the FID is optimized. Once the FID is optimized test samples of a reference gas may be run to determine the FID response to those samples.

A breakthrough calibration curve plots the response voltages of an FID against the moles of carbon in the reference gas flow rate over time. A breakthrough calibration curve is produced by feeding known amounts of the reference gas to an FID and recording the responses associated with the various reference gas flow rates. Hexane gas was used as the reference gas for this example but it is understood that other gases could also be used to create breakthrough time calibration curves according to the present invention.

In order to plot the response signals of the FID against the number of moles of carbon per minute detected by the FID, the mass flow of reference gas, or hexane, per volume of gas flow must be known. The reference gas used to produce the breakthrough time calibration curve may come from a known sample, in this case a known sample of 5 ppm hexane in a pressurized cylinder. The reference gas can be combined with a carrier gas which makes up the balance of the gas flow fed to an FID. Although the parts per million of hexane in the cylinder is known (5 ppm), it is preferable to know the gravimetric weights of hexane and carrier gas in the cylinder so that the exact mass of hexane per volume of carrier gas is known. Knowing the gravimetric weights of the reference gas and carrier gas in the reference gas supply allows the calculation of the mass of hexane per volume of carrier gas fed to the FIDs. The mass of carrier gas may be converted to volume of carrier gas using Equation 1:
Mass Carrier Gas*(1 mole Carrier Gas/Molecular Weight Carrier Gas)*(Vol Carrier Gas/mole Carrier Gas)=Volume of Carrier Gas
The mass of reference gas per volume can then be calculated because the mass of reference gas in the cylinder is known from the gravimetric value of reference gas added to the cylinder. For instance, in this example nitrogen and hexane were added to the cylinder which comprised the 5 ppm hexane standard from which the flows of reference gas were tested. Using Equation 1 and mass conversion rates, the mass of hexane per volume of gas flow from the cylinder was calculated to be 0.01991 ug of hexane per mL of gas from the cylinder.

Various gas flow rates were fed to the FID and the responses of the FID were recorded as illustrated in Table 1. The flow rates were multiplied by the calculated value of the mass of hexane per milliliter of gas flow from the cylinder (0.01991 ug hexane/mL of gas) to arrive at the mass of hexane per minute. This value is illustrated in Table 1. The number of moles of carbon per minute were calculated by converting the mass flow of hexane per minute to the mass flow of hexane in grams per minute, dividing by the molecular weight of the reference gas (hexane) and multiplying by the number of carbon atoms in the reference gas (6 carbons). The resulting moles of carbon per minute is shown in Table 1.

TABLE 1

| Flow Rate | FID Response | | |
|---|---|---|---|
| (mL/min) | (volts) | ug hexane/min | moles carbon/min |
| 56.5 | 0.1172 | 1.124915 | 7.83185E−08 |
| 44.3 | 0.0902 | 0.882013 | 6.14073E−08 |
| 36.3 | 0.0732 | 0.722733 | 5.03179E−08 |
| 26.5 | 0.0537 | 0.527615 | 3.67335E−08 |
| 16.5 | 0.0342 | 0.328515 | 2.28718E−08 |

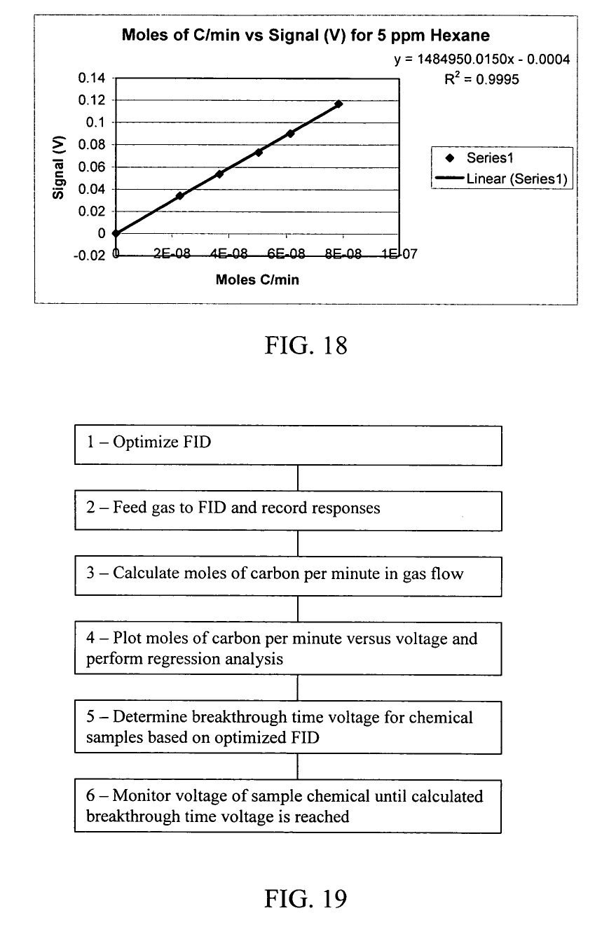

The signal of the FID in volts is plotted against the number of moles of carbon per minute flowing into the FID. A plot of the data for this example is illustrated in FIG. 18. Regression analysis of the linear curve results in the following equation for the linear curve:
y=1484950.015*x−0.0004 (Eq. 2)
where y is the voltage and x is the number of moles of carbon per minute being fed to the FID to produce the response y.

The breakthrough time is the time in minutes after initial exposure of chemical to an outer surface of a protective material that it takes to detect the chemical on the other side of the protective material. The ASTM F739 Permeation Testing Standards set the breakthrough time as that point in time wherein 0.1 milligrams per square centimeter per minute are detected on the non-exposed side of the protective material. Since the breakthrough time is defined as a mass of chemical per surface area per minute, the number of moles of carbon per minute corresponding to the breakthrough time may be determined if the surface area of the protective material being sampled is known. Using a liquid permeation testing device having a protective material sample area of 5.067 square centimeters, the breakthrough time for hexane can be determined by the standard ASTM F739 definition using Equation 3 as follows:
0.1 ug/cm2/min*(1 mg/1000 ug)*(1 g/1000 mg)*(1 mole/molecular weight of reference gas)*number of carbon atoms in reference gas*area of sample=moles of carbon per minute at the breakthrough time
Thus, based upon the definition of breakthrough time and the sample size, the number of moles of carbon per minute required to reach the breakthrough time can be calculated.

Using Equation 2 from the breakthrough time calibration curve the voltage corresponding to the breakthrough point can be calculated by substituting the number of moles of carbon per minute required to reach the breakthrough time for x and solving for y. The solution for y corresponds to the voltage at which the breakthrough concentration of 0.1 ug/cm2/min has been reached for the particular chemical component.

Table 2 displays a listing of sample chemicals (including the reference chemical hexane) with calculated moles of carbon per minute at the breakthrough time. The corresponding number of carbons is also shown in Table 2 along with the molecular weight of each chemical. The calculated breakthrough time corresponding to the moles of carbon per minute is also shown.

TABLE 2

| | MW | | Breakthrough | |
|---|---|---|---|---|
| Sample ID | solvent | # of Carbons | Point (volts) | mol C/min |
| hexane | 86.18 | 6 | 0.0524 | 3.528E−08 |
| acetone | 58.08 | 3 | 0.0389 | 2.617E−08 |
| toluene | 92.14 | 7 | 0.0572 | 3.849E−08 |
| methanol | 32 | 1 | 0.0235 | 1.583E−08 |
| MEK | 72.11 | 4 | 0.0417 | 2.811E−08 |
| MMA | 100.12 | 5 | 0.0376 | 2.53E−08 |
| formaldehyde | 30.03 | 1 | 0.0251 | 1.687E−08 |
| glutaraldehyde | 100.12 | 5 | 0.0376 | 2.53E−08 |
| 2-Propanol | 60.1 | 3 | 0.0376 | 2.529E−08 |
| Ethyl alcohol | 46.07 | 2 | 0.0327 | 2.2E−08 |
| DMF | 73.1 | 3 | 0.0309 | 2.079E−08 |
| DMSO | 84.18 | 2 | 0.0179 | 1.204E−08 |
| vertrel XE | 250 | 5 | 0.0150 | 1.013E−08 |
| benzaldehyde | 106 | 7 | 0.0497 | 3.346E−08 |
| chloroform | 119.4 | 1 | 0.0063 | 4.244E−09 |
| Trichloroethylene | 131.4 | 2 | 0.0115 | 7.712E−09 |
| Perchloroethylene | 165.8 | 2 | 0.0091 | 6.112E−09 |
| Xylene | 106 | 8 | 0.0568 | 3.824E−08 |
| ether | 74 | 4 | 0.0407 | 2.739E−08 |
| ethyl acetate | 88 | 4 | 0.0342 | 2.303E−08 |
| nitrobenzene | 123 | 6 | 0.0367 | 2.472E−08 |
| methylene | 84.9 | 1 | 0.0089 | 5.968E−09 |
| chloride | | | | |
| carbon | 153.8 | 1 | 0.0049 | 3.295E−09 |
| tetrachloride | | | | |
| glycerol | 92 | 3 | 0.0245 | 1.652E−08 |

Using the data from Table 2, the breakthrough time of a chemical, such as methanol, for a protective material may be determined using a liquid permeation testing device according to embodiments of the present invention. The protective material is placed in a sample tube with methanol on the exposed side of the protective material. The other side of the sample tube is contacted with a flow of gas which is fed to an FID or a liquid permeation testing device according to embodiments of the present invention. As the methanol flows through the protective material it is transported by the carrier gas to the FID. The breakthrough time is that time between the initial contact of the protective material with the methanol and the time it takes the FID to register 0.0235 volts which is the calculated breakthrough voltage based upon the breakthrough calibration curve.

The flow diagram shown in FIG. 19 illustrates the process for creating a breakthrough time calibration curve according to embodiments of the present invention. In step 1 an FID is optimized. In step 2 various flow rates of a reference gas are fed to the FID and the corresponding responses recorded. Step 3 involves the calculation of the moles of carbon per minute in the flow rates of the reference gas. The moles of carbon per minute are plotted against the corresponding voltage readings in step 4 and a regression analysis is performed to determine an equation for the linear curve. In step 5 the breakthrough time voltage readings for the optimized FID are determined for sample chemicals. In step 6, the breakthrough times for sample chemicals are determined by monitoring voltage responses of the FID for the sample chemicals and comparing the voltage readings to the calculated breakthrough times.

According to other embodiments of the present invention the steady state permeation rate of a sample gas can be determined using a calibration curve developed from optimized FID response data for a reference chemical. The FID is first optimized to produce a linear curve as shown in FIG. 11 using a reference gas according to the methods described with respect to FIG. 11.

Multiple samples of known quantities of a reference gas are then fed to the FID and the responses corresponding to each feed are recorded. For example, hexane samples from known 1000 ppm, 2500 ppm, and 5000 ppm hexane gas cylinders are fed to the optimized FID and the corresponding voltages are recorded as illustrated in Table 3.

TABLE 3

| | | | | |
|---|---|---|---|---|
| ml/min | volts | ug/min | moles C/min | volts |

1000 ppm hexane

| | | | | |
|---|---|---|---|---|
| 52.8 | 0.0147 | 204.336 | 1.42262E−05 | 0.0147 |
| 43.8 | 0.012 | 169.506 | 1.18013E−05 | 0.012 |
| 31.8 | 0.0086 | 123.066 | 8.56807E−06 | 0.0086 |
| 21.2 | 0.0051 | 82.044 | 5.71204E−06 | 0.0051 |
| 12.4 | 0.0022 | 47.988 | 3.34101E−06 | 0.0022 |

2500 ppm hexane

| | | | | |
|---|---|---|---|---|
| 52.9 | 0.0405 | 507.0465 | 3.53015E−05 | 0.0405 |
| 41.7 | 0.0307 | 399.6945 | 2.78274E−05 | 0.0307 |
| 31.3 | 0.0222 | 300.0105 | 2.08872E−05 | 0.0222 |
| 20.8 | 0.0143 | 199.368 | 1.38803E−05 | 0.0143 |
| 11.4 | 0.0071 | 109.269 | 7.6075E−06 | 0.0071 |

5000 ppm hexane

| | | | | |
|---|---|---|---|---|
| 53.8 | 0.088 | 1032.96 | 7.19165E−05 | 0.088 |
| 43.2 | 0.0725 | 829.44 | 5.7747E−05 | 0.0725 |
| 34.2 | 0.0501 | 656.64 | 4.57164E−05 | 0.0501 |
| 23.7 | 0.0383 | 455.04 | 3.16807E−05 | 0.0383 |
| 10.3 | 0.0146 | 197.76 | 1.37684E−05 | 0.0146 |

The mass flow of hexane per volume for each of the cylinders may be calculated from the gravimetric values of hexane and carrier gas (nitrogen) added to each of the cylinders. The mass flow of hexane per minute is calculated from the mass flow of hexane per volume and the volumetric flow per minute of the hexane and carrier gas. The number of moles of carbon flowing per minute for each volumetric flow per minute is calculated by converting the mass flow of hexane per minute to the mass flow of hexane in grams per minute, dividing by the molecular weight of the reference gas (hexane) and multiplying by the number of carbon atoms in the reference gas (6 carbons). The resulting moles of carbon per minute is listed in Table 3.

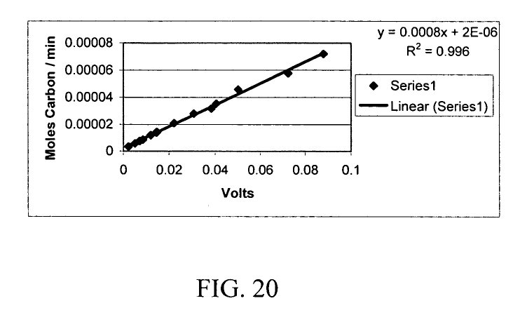

A plot of the moles of carbon per minute versus the FID responses (volts) results in the linear curve illustrated in FIG. 20. Regression analysis of the linear curve produces an equation for the curve, which in the illustrated example is:
y=0.0008*x+2.34E-06
wherein y is the number of moles of carbon per minute and x is the voltage corresponding to the time at which steady state permeation exists.

For various chemical samples the flow rate of moles of carbon per minute can be calculated from the mass flow per volume of the sample being tested. The expected voltage response of the FID for the corresponding number of moles of carbon at steady state is calculated for sample chemicals. To determine the amount of time it takes to reach steady state permeation the time that it takes an FID to register the volts corresponding to the predicted steady state permeation is monitored. Once the corresponding voltage is reached, steady state permeation of a chemical sample is occurring.

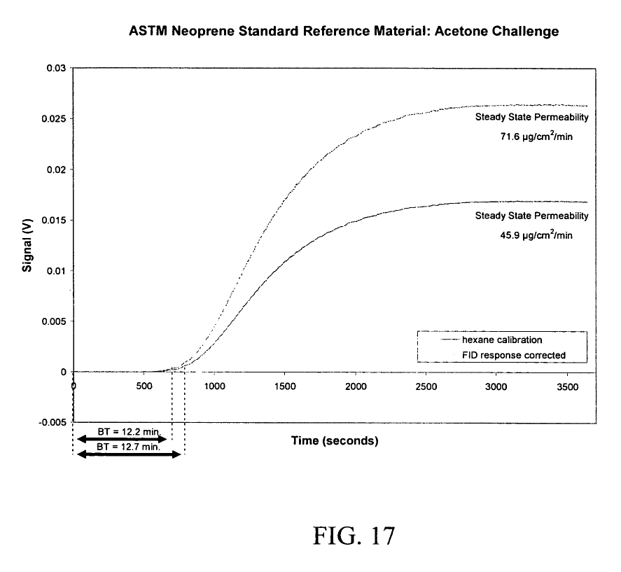

In permeation testing using a universal calibration procedure, errors associated with the FID response result in errors in the breakthrough time and steady state permeation rate measurements. These two measurements respond very differently to the calibration error, however. This can be seen in FIG. 17, which shows the FID response for an acetone permeation experiment using the ASTM F739 Neoprene standard reference material. The lower curve is the actual FID signal. Since the permeation system was calibrated using hexane, using this data directly corresponds to the first approach for relating the FID response of the sample material to the calibration material (i.e. assuming that acetone has a similar carbon response factor to hexane). The upper curve in FIG. 17 was generated by taking the response factor of acetone relative to hexane into account. This corresponds to the second approach for relating the FID response for a sample to the reference material and should result in minimal error. Acetone deviates strongly from a hydrocarbon-like response in an FID. It exhibits a significantly reduced FID response relative to hexane, having a RCRF of only 0.64 for that of hexane. The corresponding error in the FID response associated with assuming a similar carbon response factor to hexane is 36%. This error manifests itself directly in the steady state permeation rate; the application of a hexane calibration curve for an acetone sample will underestimate the steady state permeation rate by 36%. The effect on the breakthrough time is much smaller than the FID response error. By assuming a similar carbon response factor for acetone and hexane, the error in the breakthrough time measurement is less than 5%. To summarize, in liquid permeation experiments, the error associated with the FID response for the sample material relative to the calibration material is seen as a proportional error in the steady state permeation rate. In contrast, the corresponding error in the breakthrough time is much smaller than the FID response error. This is important, since in many applications, breakthrough time is the critical parameter for selecting protective clothing such as gloves.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

1. A continuous monitoring device, comprising:
at least one sample port to accommodate one or more ASTM sampling cells;
at least one mass flow controller in communication with said at least one sample port;
at least one flame ionization detector in communication with said at least one mass flow controller;
at least one electrometer in communication with said at least one flame ionization detector;
at least one computing system in communication with said at least one electrometer; and
wherein said continuos sample monitoring device associates a voltage response to a chemical sample fed to said at least one sample port.

2. The sampling device of claim 1, wherein said at least one flame ionization detector is heated.

3. The sampling device of claim 1, wherein said sampling device is enclosed as a stand-alone unit.

4. The sampling device of claim 1, further including at least one gas divider.

5. A method of calibrating a flame ionization detector, comprising optimizing a linear response from the flame ionization detector for a known gas sample.

6. A method of calibrating a flame ionization detector, comprising:
feeding a constant flow rate of gas to the flame ionization detector;
altering a volumetric amount of a reference gas sample in the constant flow rate;
determining a resulting signal from the flame ionization detector for each of a plurality of altered volumetric amounts of gas sample; and
plotting the resulting signals of the plurality of altered volumetric amounts of gas sample as a linear curve.

7. The method of claim 6, wherein the linear curve produces a reference for determining the breakthrough time for chemical samples based upon the carbon number of the chemical sample and the reference gas sample.

8. The method of claim 6, wherein the linear curve produces a reference for determining the steady state permeation rate for chemical samples based upon the carbon number of the chemical sample and the reference gas sample.

9. A method for determining the breakthrough time of a chemical sample, comprising:
obtaining a linear calibration curve from flame ionization detector responses to a reference gas;
calculating a predicted flame ionization detector response for the breakthrough time of a chemical sample based upon the number of carbons in the chemical sample and the reference gas; and
measuring the amount of time required to reach the calculated predicted flame ionization detector response for the chemical sample.

10. A method for determining the steady state permeation rate of a chemical sample, comprising:
obtaining a linear calibration curve from flame ionization detector responses to a reference gas;
calculating a predicted flame ionization detector response for the steady state permeation rate of a chemical sample based upon the number of carbons in the chemical sample and the reference gas; and
measuring the amount of time required to reach the calculated predicted flame ionization detector response for the chemical sample.

11. A continuous monitoring device, comprising:
at least one sample port for receiving one or more sampling cells wherein a sampling cell comprises a first chamber, a material, and a second chamber, wherein the first chamber contains a chemical and is separated from the second chamber by the material;
at least one mass flow controller in communication with the at least one sample port for providing at least one flow of gas to the second chamber of a sampling cell in the at least one sample port;
at least one flame ionization detector in communication with the at least one flow of gas from the at least one mass flow controller wherein the at least one flame ionization detector produces a voltage response in response to the at least one flow of gas; and
at least one computing system in communication with the at least one flame ionization detector for receiving the voltage response.

12. The continuous monitoring device of claim 11, further comprising at least one electrometer in communication with the at least one flame ionization detector and the at least one computing system wherein the at least one electrometer receives a voltage response from the at least one flame ionization detector and transmits the voltage response to the at least one computing system.

13. The continuous monitoring device of claim 11, wherein the at least one flame ionization detector is heated.

14. The continuous monitoring device of claim 11, further comprising a gas divider for regulating the flow of a gas to the at least one flame ionization detector.

15. The continuous monitoring device of claim 11, wherein the at least one computing system comprises software for converting voltage responses into data selected from the group consisting of visual data and numerical data.
